(19) United States
(12) Patent Application Publication
(10) Pub. No.: US 2013/0138480 A1
(43) Pub. Date: May 30, 2013

(54) Method and apparatus for exploring and selecting data sources

(71) Applicants: Xin Luna Dong, Morristown, NJ (US); Divesh Srivastava, Summit, NJ (US)

(72) Inventors: Xin Luna Dong, Morristown, NJ (US); Divesh Srivastava, Summit, NJ (US)

(21) Appl. No.: 13/373,791

(22) Filed: Nov. 30, 2011

(51) Int. Cl. G06Q 40/00; G06Q 10/00; G06F 17/30

(52) U.S. Cl. 705/7.36; 707/737; 707/E17.089

(57) ABSTRACT

A system and method for choosing data sources for use in a data repository first chooses an initial selection of data sources based on keywords. An exploration tool is provided to organize the sources according to content and other attributes. The tool is used to pre-select data sources. The sources to include in the data repository are then selected based on a marginalism economic theory that considers both costs and quality of data.

### FIELD OF THE DISCLOSURE

The present disclosure relates generally to aggregating large quantities of data, and more specifically to exploring and selecting data sources for the purpose of increasing the quality of integrated data in a data repository while using fewer resources.

### BACKGROUND

Advanced information technologies have led to an information era. A large volume of data is available from Websites, blogs, online social networks, collaborative annotations, social bookmarking, and data generated by sensors, mobile devices, personal equipment, and so on. While there is an abundance of useful and easily-shared information, the experience of understanding, analyzing, and using this overwhelming amount of information is not always pleasant and can even be painful and frustrating. The existence of “too much data” has therefore become a significant problem. While data aggregators attempt to address these problems, the data aggregators themselves face the similar issue of too many data sources.

### SUMMARY OF THE DISCLOSURE

In accordance with one aspect of the present disclosure, there is disclosed a method for searching for selecting data sources for use in a data repository. The method generally comprises clustering, by a processor, potential data sources into domains based on a content of data included in the potential data sources; determining, by the processor, relationships between the domains; displaying, on a graphical user interface, a depiction of the potential data sources, the depiction including representations of the potential data sources clustered into the domains, the depiction further including representations of the relationships between the domains; and receiving an identification of at least one user-identified data source of the potential data sources for use in the data repository.

In accordance with another aspect of the present disclosure, there is disclosed a method for selecting data sources for use in a data repository. The method comprises receiving an identification of a plurality of data sources in a particular subject matter domain; and receiving, for each of the data sources, a measure of cost to use the data source; by a processor, determining a subset of the plurality of data sources in the particular domain yielding a maximum global economic effectiveness for the data repository, the global economic effectiveness being an overall quality of searches conducted using the data repository, discounted by the costs of the data sources in the data repository.

In accordance with another aspect of the present disclosure, a tangible computer-usable medium includes computer readable instructions stored thereon for execution by one or more processors to perform one or more of the above methods.

These aspects of the disclosure and further advantages thereof will become apparent to those skilled in the art as the present disclosure is described with particular reference to the accompanying drawings.

### BRIEF DESCRIPTION OF THE DRAWINGS

FIG. 1 is a graph showing coverage of possible results as a function of the number of sources, from a sample study.

FIG. 2 is a graph showing the number of correctly returned authors as a function of the number of sources, from a sample study.

FIG. 3 is a schematic view of a data source management system in accordance with an embodiment of the disclosure.

FIG. 3A is a sample graphical depiction of a source exploration tool in accordance with an embodiment of the disclosure.

FIG. 4 is a table showing examples of data sources used by the system and method of the disclosure.

FIG. 5 is a schematic diagram of a computer system used in implementing methods in accordance with the present disclosure.

### DETAILED DESCRIPTION

Despite the huge amount of effort that has been put into improving Web searching and the dramatic change Web search engines have brought to people's daily lives, Internet users are still often overwhelmed by the number of answers returned for a keyword search. Part of the reason is that there is a lot of redundancy on the Web, leaving the user the task of finding duplicates or variants. As an example, consider a home buyer who searches “New Jersey real estate” on the Web. A leading Web search engine returns 27 million Web pages (at the time the search was done), among which the top eight are all real-estate search engines, and there is considerable overlap between their results. The home buyer certainly does not need to go to each of them, but it would be hard for her to decide which Web site to resort to.

On the other hand, relevant information may not be included in the returned results. Continuing with the home buyer example, the top 50 returned Web pages for the query “New Jersey real estate” include no information about school district, crime rate, transportation, pollution situation, etc. Unless the home buyer has those concerns in mind and formulates new searches on them, she may not get such information or even be aware that such information is important in making a home-buying decision. Paradoxically, returning such information in addition to the many home search websites as search results can add extra burden on the users and aggravate the problem of information overload.

There exist data repositories or data integration systems that aggregate data on the Web. The repository may include a general aggregation of all available information on the Web, as is the case with the widely-used large Web search engines, or the repository may be for a more specific purpose, such as an aggregation of real estate information for a certain market. As used herein, the term “data repository” means a collection of data that is either general purpose or specific purpose. The collection need not be physically centralized, but may instead be a distributed system with the locations of the data being indexed. Data aggregators create data repositories by selecting data sources from among the large number of available data sources.

There is a large cost associated with the large amount of information on the Web. While end users often benefit from search engines, data integration systems and data repositories in that they do not need to go through the billions of websites or many data sources manually for retrieving data, data aggregation and integration systems themselves often must pay a huge cost for processing, cleaning, and indexing the data from various sources. Data aggregators may need to purchase data from some data providers. Even for sources that are free, data aggregators must spend resources on mapping heterogeneous data items, resolving conflicts, cleaning the data, and so on. Some of that expense, however, may not be worthwhile, if the gain from integrating the data is limited.

To illustrate this, experiments were conducted on a data set extracted by searching computer science books on an online bookstore aggregator, AbeBooks.com®. In that data set, there are 894 bookstores (each corresponding to a data provider) and they provide information in total on 1265 books. For each book, a data source provides information on its ISBN, title, and authors. Initially, the sources were incrementally accessed in decreasing order of their coverage.

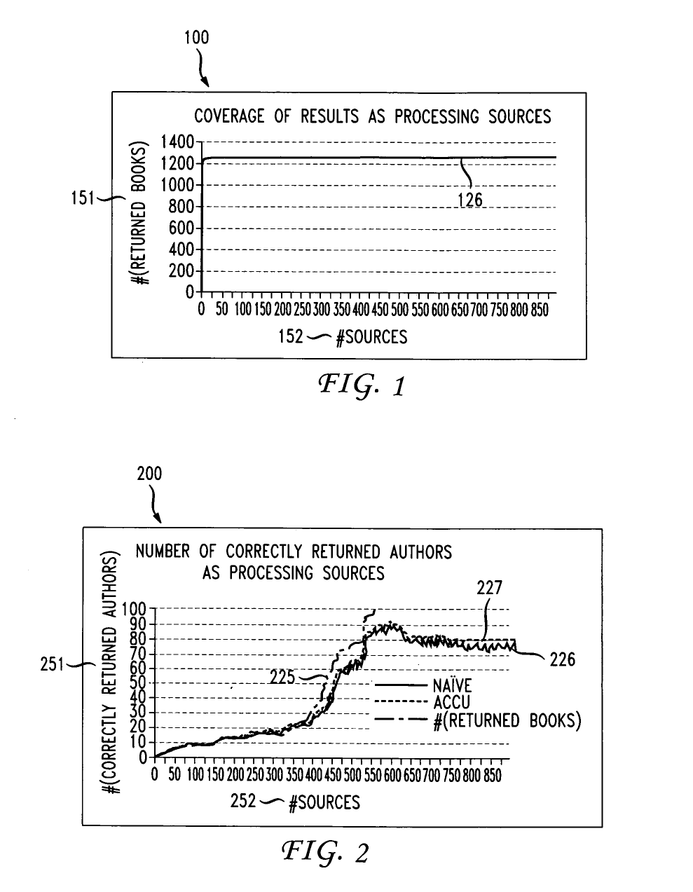

A graph 100, shown in FIG. 1, illustrates a curve 126 relating the total number of books retrieved (axis 151) as a function of the number of sources (axis 152) accessed. It is observed that the largest (first) source provides information for 1096 books (86%), and the largest two sources together provide information for 1213 books (96%). After aggregating data from 10 sources, information for 1250 books was obtained. After 35 sources, information for 1260 books was obtained; after 537 sources, information for all 1265 books was provided. If the goal is merely to provide information for computer science books at a particular time, and consistency of the information is assumed, it is obviously not necessary to integrate data from all sources; if integrating each source is costly while having slightly lower completeness is acceptable, it may not be worthwhile to integrate data from sources that contribute information for only one or two extra books.

Search quality can deteriorate as a result of too much data. As one can freely publish data on the Web, there exists a large volume of low-quality data, being out-of-date, inaccurate, or erroneous. In a sense, the redundancy on the Web makes it possible to benefit from the collective intelligence to fix errors from some sources. For example, searching “US capital” using one popular Web search engine returns “Washington, D.C.” and the sources that support this fact. Ironically, considering all available data sources, including low-quality ones, may actually hurt the correctness of decisions.

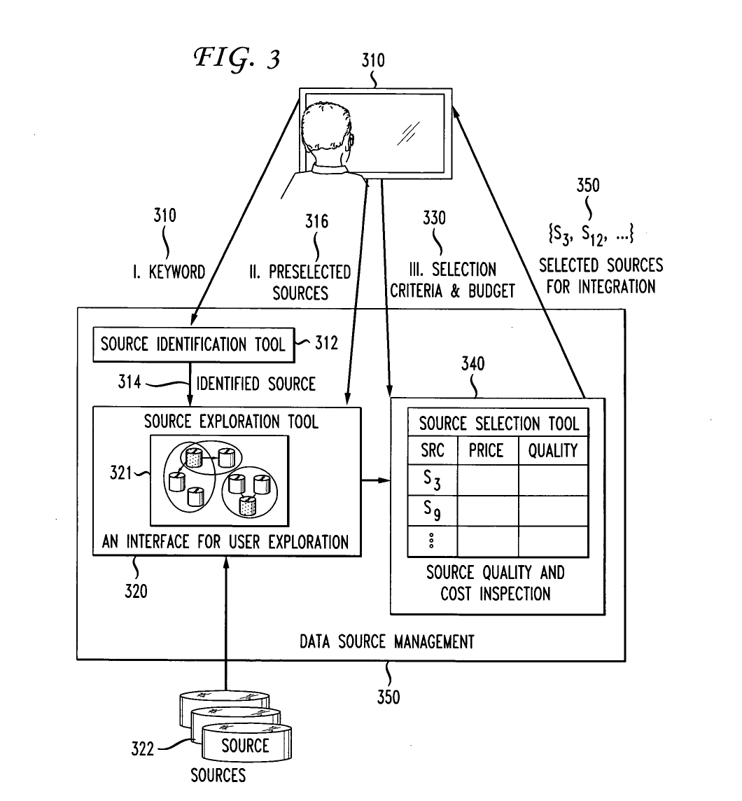

To illustrate this, the experiment on the AbeBooks.com® data is continued, with the data sources being processed in decreasing order of their accuracy, with the aim of finding the correct author list for each book. As illustrated in the graph 200 of FIG. 2, two techniques are used: a “NAÏVE” approach 226 applies voting and chooses the author list provided by the largest number of sources; an “ACCU” approach 227 considers in addition the accuracy of the data sources and gives greater weight to sources that have higher accuracy. Techniques described in X. L. Dong, L. Berti-Equille, and D. Srivastava, Integrating conflicting data: the role of source dependence, PVLDB, 2(1), 2009, the contents of which is incorporated by reference in its entirety herein, are used to decide source accuracy and take it as input. The results of the two methods are compared against a “gold standard” 225 on one hundred randomly selected books, obtained by manually checking book covers. The graph 200 plots the number of correctly returned author lists for these hundred books, as a function of the number of sources 252. It can be seen that the number of correctly returned author lists 251 increased at the beginning as data was obtained on more books and errors from early observations were fixed. All 100 books were obtained after processing 548 sources, as shown by the line 255. Beyond 548 sources, the number of correct author lists for both the NAIVE and ACCU methods continues increasing for a while until reaching over 90, and then drops. After all sources are processed, the number of correct author lists drops to 78 and 80, respectively, for the NAIVE and ACCU techniques. While ACCU is, in general, better than NAIVE, it is observed that the result of ACCU on all sources is not as good as that of NAIVE on the first 582 sources.

Data sources can also easily copy, reformat, and modify data from other sources, thus propagating low-quality information. Examples abound of the damage that copied false information can cause.

The above analysis shows that for data and information, “the more the better” does not necessarily hold and sometimes “less is more.” The present disclosure presents systems and methods for helping data aggregators explore the available data sources and select the best set of sources for integration. The disclosed systems and methods seek to achieve that goal in three steps. First, given a keyword query, data sources that may be relevant are identified. Second, a source exploration tool is provided, showing the big picture of available sources and highlighting the identified relevant sources. With such a tool, data aggregators can (1) understand the domain and contents of the identified sources and discover related sources that may be of interest, and (2) understand the quality (e.g., coverage, accuracy, timeliness) of the sources and the relationships (e.g., data overlap, copying relationship) between them. Data aggregators can use this tool to refine their information needs (e.g., collecting precise data for computer science books) and pre-select the sources that are of particular interest to them. Third, according to the specified criteria and budget, and a set of preselected data sources, the disclosed system recommends the best subset of sources that together balance the gain, which is determined by the quality of the integration results, and the cost, including data purchase, integration, and cleaning cost.

The presently disclosed systems and methods have several high-level goals. First, many techniques, including Web search and data integration, try to exploit as much data as possible; in contrast, the presently disclosed technique makes wise choices on the data to be processed such that even better results are obtained from a subset of data. Second, when cost and gain are balanced, the traditional approach often optimizes one under some constraint on the other; in contrast, the presently disclosed technique looks for a solution where no more cost can be spent with significant gain. Third, using current techniques, accessing a large volume of data is often through pulling, triggered by searching and querying, and requiring the users to know fairly well what they are looking for; in contrast, the presently disclosed technique seeks an effective way for exploration, such that a user can easily find and understand “what is out there.”

Embodiments of the disclosure will be described with reference to the accompanying drawing figures wherein like numbers represent like elements throughout. It is to be understood that the disclosure is not to be limited in its application to the details of the examples set forth in the following description and/or illustrated in the figures. The disclosure is capable of other embodiments and of being practiced or carried out in a variety of applications. Also, it is to be understood that the phraseology and terminology used herein is for the purpose of description and should not be regarded as limiting. The use of “including,” “comprising,” or “having” and variations thereof is meant to encompass the items listed thereafter and equivalents thereof as well as additional items.

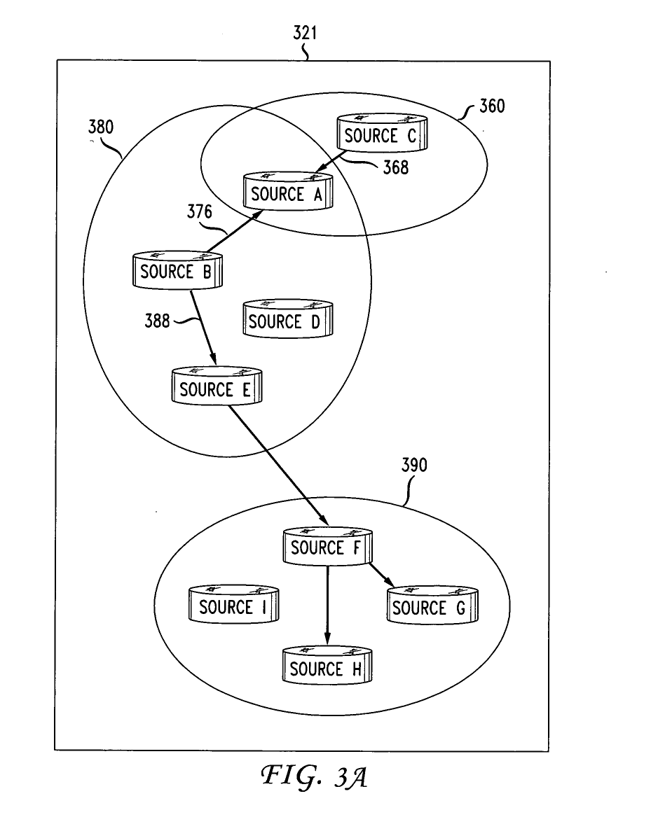

The goal of the presently described systems and methods is to facilitate source exploration and selection. The workflow and components of the presently described data source management system 350 are shown FIG. 3. The system may be described with reference to three components. First, a source identification tool 312 takes a keyword query 310 and identifies sources 314 that may be relevant.

Second, a source exploration tool 320 provides an interface with which the user can explore the identified relevant sources and their related sources. The tool 320 displays a graphical depiction 321 of the sources 322. An enlarged view of the graphical depiction 321 is shown in FIG. 3A. Sources that are in the same domain are clustered into domains such as domains 360, 380, 390. Related domains such as domains 360, 380 and domains 380, 390 are depicted close to each other in the graph. Domains containing some common data sources, such as domains 360, 380, are shown as intersecting ovals. Each domain may be represented by an oval, as shown.

A relevant source that has been identified by a user may be highlighted, as by changing the color of the representation of that source. When the user zooms in on a particular cluster, she can see more sources, relationships between the sources, sub-clusters and correlations between the clusters. Each copying relationship may be represented by an arrow. For example, source A is indicated by arrows 368, 376 to contain information copied from source B and source C, respectively; source E is shown by arrow 388 to contain information copied from source B. The user can also switch to a quality view that compares the quality of the sources, such as coverage, accuracy, and freshness of the sources. In the example shown in FIG. 3A, source B and source F are shown in bold lines, indicating that they are high quality sources. Sources A, E, D and F are shown with normal weight lines, indicating normal quality. Sources C, G and I are shown with light lines, indicating low quality. Color, font and other indicia may alternatively be used to indicate various characteristics of the sources such as cost or components of quality such as freshness.

Returning to FIG. 3, a data aggregator uses the tool 320 to pre-select a set of sources 316 that are of particular interest. In one embodiment, the data aggregator uses a pointing device such as a mouse to indicate choices on the graphical depiction 321.

Third, a source selection tool 340 takes the pre-selected sources 316 and some desired criteria 330 specified by the data aggregator, such as “collecting information for NYC restaurants, emphasizing completeness and freshness of results,” gives details about the cost and quality of each pre-selected source, and recommends the best subset (or sequence) of sources 350 to integrate or aggregate.

The following scenario demonstrates how the presently disclosed methods can benefit data aggregators or integrators, and even individual data aggregators. Consider a data provider that wishes to aggregate home-buying information for New Jersey. The presently disclosed system maintains a list of commercial data providers and also deep Web sources (i.e., sources that support Web-form search on their underlying databases). The data provider inputs “NJ real estate” and the system identifies a set of relevant data sources containing the keywords. The system then displays graphical depiction of the data sources that it knows, highlights the identified relevant sources, and focuses on the domains that contain those sources. According to the graphical depiction, the data provider realizes that the sources can belong to different domains, such as “real estate” and “local information.” When the data provider chooses a particular domain such as “local information” to zoom in, the system displays subdomains such as “public transportation,” “education,” “crime,” “business listings” and so on. Some domains, such as “education,” may not contain any identified relevant source, but by source exploration, the data provider will be aware of such related domains because those related domains are represented in the graphical depiction close to domains containing relevant sources. For a particular domain, such as “real-estate listing,” the data provider may wish to compare the many sources, including their coverage, the freshness of the data, overlap between the sources, and so on. The data provider can then enable the quality view feature of the source explorer and see the quality measures of the sources.

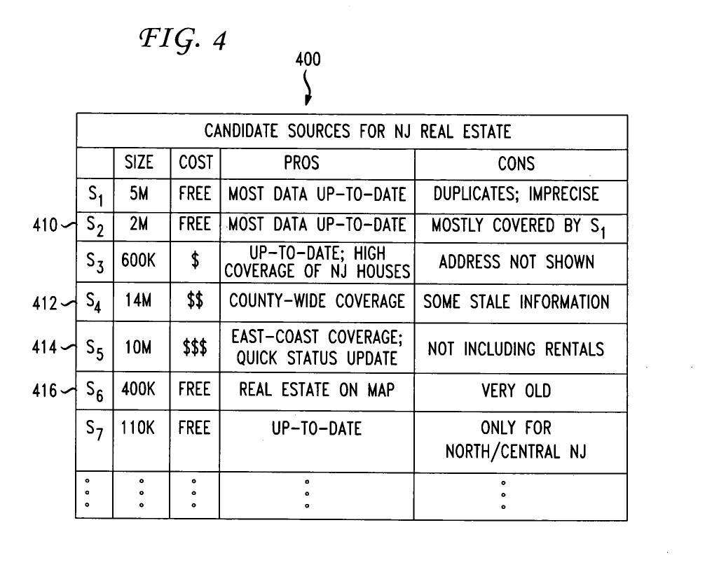

Through exploring the data sources, the data provider identifies some sources that are potentially interesting. However, aggregating data from all sources may be too costly either because of the purchase cost or because of the aggregation cost. The data provider then pre-selects sources from each sub-domain, and specifies the information need. For example, the data provider may pre-select a set of real-estate listing sources, and require finding “sources for NJ real estate, emphasizing completeness and freshness of data.” The presently described system then shows the cost and quality of the sources, either at a high level, as shown in table 400 of FIG. 4, or giving quantification of various quality measures. For this particular example, it is obviously not necessary to aggregate data from all sources. For example, as shown in entry 410 of the table 400, the data of source S2 are mostly covered by source S1 and so may be skipped; as shown in entry 416, the data of source S6 are low-quality and can be skipped; as shown in entries 412, 414, the data from sources S4 and S5 are expensive and may be overkill for the purpose of collecting data only for the New Jersey area. The presently disclosed system then recommends a subset of sources according to the specified information need, based on information such as that shown in Table 400.

Source Exploration

To facilitate the source selection process 340, the presently described system identifies sources that may be relevant according to keyword search, and provides an exploration tool 320 (FIG. 3) with which the data aggregator can explore and understand the content and quality of the sources. While considerable work has been done on source identification, the present discussion focuses on source exploration.

Visualization and exploration of sources by quality is discussed by X. L. Dong, L. Berti-Equille, Y. Hu, and D. Srivastava, Solomon: Seeking the truth via copying detection (PVLDB 2010), which is hereby incorporated by reference in its entirety herein. Exploration by content, on the other hand, requires clustering sources into domains and finding correlation between domains. For the former, the clustering can be soft (one source can belong to several domains), and hierarchical (one domain can contain several sub-domains). While there have been several works on clustering unstructured texts, works on clustering structured sources are still in their infancy and are limited to single-table sources based on attribute-name similarity. For more complex sources, clustering may consider evidence from the schema (tables and attributes), the data instances, and even the internal structure (key and foreign key). Shared elements (e.g., table names, attribute names, data instances, and foreign-key links) may be found between each pair of sources and modularity clustering applied accordingly. Popular and unpopular elements may also be distinguished (using measures similar to IDF or information entropy) in clustering.

To find relationships between domains, correlation may be considered between the sources in different domains. Correlation may also be inferred from co-occurrence of topics (summarized by frequently appearing keywords) in external sources such as blogs. For example, many home-buying blog articles may mention both home buying and school district, implying strong correlation between the real-estate domain and the school-district domain.

Clustering sources by content: Despite the many works on clustering, leveraging the structural information and overlapping data instances for clustering structured sources remains very challenging. The problem is even harder because the domains can be soft and hierarchical, and the availability of all data from the sources cannot be assumed. Often, sampled data must be relied upon. Automated techniques may be used that cluster the sources according to their schema and data.

Correlating domains: Domain correlation can be derived from correlation between sources in the domains, which requires analysis of correlation or content overlapping between sources, or from co-occurrence of keywords in external sources, which requires summarizing the domains by frequently occurring keywords and finding correlations between the keywords from a large number of Web articles. Correlation between clusters of sources may be computed according to internal and external evidence.

Measuring source quality: In addition to the content of the sources, another important criterion for source exploration is the quality of the sources. Such quality is multi-dimensional, including both intra-source measures (e.g., completeness, accuracy, freshness, redundancy, consistency) and inter-source measures (e.g., overlap, copying). Such quality indicators may be obtained from annotations, quantifying and computing these measures from samples of source data.

Visualization and exploration: The exploration tool needs to provide an adequate interface, such as the graphical depiction 321 of FIG. 3A, to help data providers easily pinpoint the sources that may be valuable to them. Such a tool should be based on summarization of sources, for which insight may be obtained from summarizing a single database. Such summarization is described in X. Yang, C. M. Procopiuc, and D. Srivastava. Summarizing relational databases PVLDB 2:634-645 (2009a0, and in C. Yu and H. V. Jagadish, Schema summarization (in VLDB 2006), the contents of which are hereby incorporated by reference herein. Such a tool will also benefit from an intuitive visualization such as the GMap technique descried in E. Gansner, Y. Hu, and S. Kobourov, GMap: Drawing graphs and clusters as map (in IEEE Pacific Visualization Symposium 2010), that shows maps of elements according to their correlation.

Source Selection

The source selection tool 340, shown in FIG. 3, will now be discussed in further detail. The source selection tool takes a set of sources in the same domain, together with selection criteria and a budget, and outputs a subset of sources that together best meet the goal within the budget. Through source selection, the redundancy of the data that must be handled in data integration or aggregation can be reduced, saving resources, and even improving the quality of the results.

Source selection falls in the category of resource optimization. Given a budget, the typical goal of resource optimization is either to find the subset of data sources that maximizes the result quality under the budget, or to find the subset that minimizes the budget while reaching a minimal requirement of quality. Neither of those proposals, however, may be ideal. Consider, for example, the sources shown in FIG. 2 and assume the applied order is the best order of exploring the sources. If the budget allows aggregating at most 300 sources; then the first 300 sources may be selected and 17 correct author lists obtained. If, however, only the first 200 sources are selected, the cost is cut by ⅓, while obtaining only 3 fewer correct author lists. Arguably, the latter selection is better. On the other hand, if the budget allows aggregating 455 sources; then all of the first 455 sources may be selected, obtaining 51 correct author lists. If, however, 461 sources are instead selected, the budget is exceeded by 1%, but 59 correct author lists are obtained (improving by 16%). Arguably, spending the little extra bit of resources is worthwhile.

The presently disclosed system uses a solution inspired by the Marginalism principle in economic theory, described in A. Marshall, Principles of Economics (1890). Under that principle, no new sources are integrated once the marginal gain is less than the marginal cost. In the above example, if it is assumed that the cost of integrating one new source is the same as the gain of increasing one percentage of the correctly discovered author lists, then the marginal points are the 30th, the 461st and the 531st sources. According to the budget, one of these points may be chosen to maximize a global economic effectiveness of the data repository. The global economic effectiveness of a given data repository is a function of both source costs and search quality. The maximum may be found iteratively by adding and/or removing data sources and locating and comparing local maxima of the function. Note, however, that applying the Marginalism principle is nontrivial in the present context for two reasons. First, the data sources are different; how much additional gain a source can provide depends both on its own quality and the relationships (such as overlap or copying) it has with already-selected sources. Second, the curves with different orderings of the sources can be very different. Thus, the present method looks for a subset of sources where adding any additional source cannot bring comparable gain, and where dropping any selected source causes more loss.

Specifying cost and gain: Many types of integration costs must be considered. First, data must be purchased from some of the sources. Second, applying the integration models takes time and machine cycles. Third, manual or semi-manual cleaning of the final results consumes labor. Costs of various types must therefore be specified and estimated. Similarly, specifying the gain with respect to quality of the integration results is also complex, because quality measure is often multi-dimensional, and the gain can be related to business models. Declarative methods are preferably used for cost and gain specification.

Estimating result quality: One important building block for source selection is to estimate the quality of integrated data. Advanced data-fusion techniques, as surveyed in X. L. Dong and F. Naumann, Data fusion—resolving data conflicts for integration (PVLDB 2009), the contents of which is incorporated herein by reference, can serve as the foundation. Those techniques consider the accuracy, freshness, and coverage of data sources, in addition to copying relationships between sources, in resolving conflicts, aiming at finding the true values reflecting the real world. Note, however, that it cannot be expected to conduct real integration and evaluate the results. Instead, the estimate is based purely on the quality of the input sources, and can differ when different models are applied.

For an extremely simple, homogeneous system, it may be possible to estimate an increase or decrease in search quality when an average or typical data source is added to or removed from the integration results. For example, suppose there are 1000 books and each source covers 60% of them and is independent of the others. It is assumed that search quality is directly related to the coverage of the integration results. The first source returns 600 books. The second source returns an additional 240 books. The third source returns an additional 96 books. The search quality therefore increases from 60% to 84% to 93.6 percent for each data source added.

Selecting sources: Current works on source selection are generally based either on query logs (for data warehousing) or on individual queries such as collaborative IS, P2P systems and sensor networks. Source selection based on quality of results according to the Marginalism principle permits the consideration of costs in the model. The underlying problem is non-trivial, however, and can become even more complicated when the different qualities of different slices of data from the same source are considered. For example, a source may provide high-quality data for restaurants but low-quality data for businesses of other categories. Thus, in some cases, only a subset of data from a source may be aggregated. Only a portion of data from each source might therefore be selected for aggregation to meet the integration criteria within the budget.

Targeting different audience: A data aggregator often has in mind the audience that would benefit from the result data set, and different audiences often have different information needs and value different aspects of the quality. For example, New Jersey residents may care more about completeness of the news for New Jersey events, whereas audiences from other states may value the promptness of important news in New Jersey.

Implementation

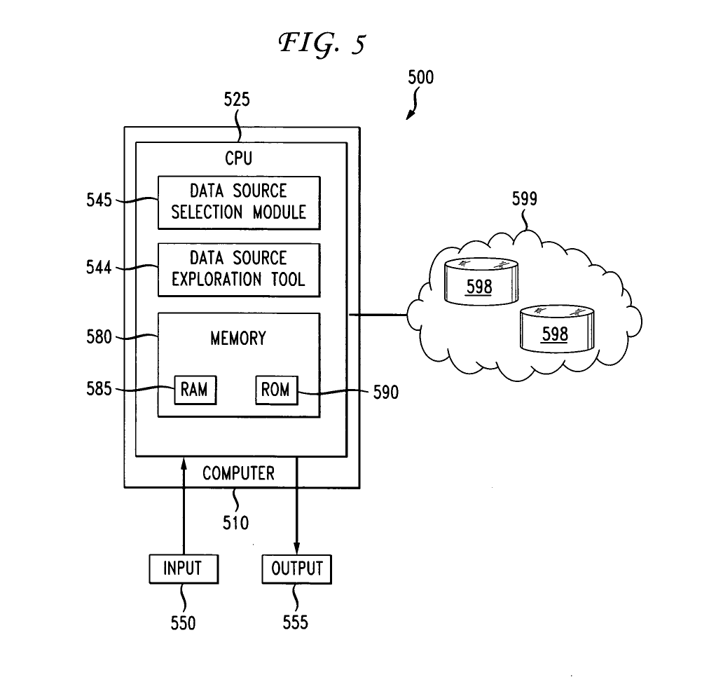

A computer system 500 for selecting data sources, according to an exemplary embodiment of the present disclosure, is illustrated in FIG. 5. In the system 500, a computer 510 performs elements of the disclosed method. While the computer 510 is shown as a single unit, one skilled in the art will recognize that the disclosed steps may be performed by a computer comprising a plurality of units linked by a network or a bus.

The computer 510 may be a mainframe, a server, a desktop computer, a laptop computer, a portable handheld device, etc. The functions of the computer 510 may be distributed among multiple computers and/or processors. The computer 510 receives data from any number of data sources 598 in one or more data networks 599 connected to the computer.

The computer 510 includes a central processing unit (CPU) 525 and a memory 580. The computer 510 may be connected to an input device 550 and an output device 555. The input 550 may be a mouse, network interface, touch screen, etc., and the output 555 may be a liquid crystal display (LCD), cathode ray tube (CRT) display, printer, etc. The computer 525 may be connected to a network, with all commands, input/output and data being passed via the network. The computer 525 can be configured to operate and display information by using, e.g., the input 550 and output 555 devices to execute certain tasks such as presenting the graphical depiction 321.

The CPU 525 may contain one or more software modules such as the data source selection module 545 and the data source exploration tool 544, as discussed herein.

The memory 580 includes a random access memory (RAM) 585 and a read-only memory (ROM) 590. The memory 580 may also include removable media such as a disk drive, tape drive, memory card, etc., or a combination thereof. The RAM 585 functions as a data memory that stores data used during execution of programs in the CPU 525 and is used as a work area. The ROM 590 functions as a program memory for storing a program executed in the CPU 525. The program may reside on the ROM 590 or on any other tangible or non-volatile computer-usable medium as computer readable instructions stored thereon for execution by the CPU 525 or another processor to perform the methods of the disclosure. The ROM 590 may also contain data for use by other programs.

The above-described method may be implemented by program modules that are executed by a computer, as described above. Generally, program modules include routines, objects, components, data structures and the like that perform particular tasks or implement particular abstract data types. The term “program” as used herein may connote a single program module or multiple program modules acting in concert. The disclosure may be implemented on a variety of types of computers, including personal computers (PCs), hand-held devices, multi-processor systems, microprocessor-based programmable consumer electronics, network PCs, mini-computers, mainframe computers and the like. The disclosure may also be employed in distributed computing environments, where tasks are performed by remote processing devices that are linked through a communications network. In a distributed computing environment, modules may be located in both local and remote memory storage devices.

An exemplary processing module for implementing the methodology above may be hardwired or stored in a separate memory that is read into a main memory of a processor or a plurality of processors from a computer readable medium such as a ROM or other type of hard magnetic drive, optical storage, tape or flash memory. In the case of a program stored in a memory media, execution of sequences of instructions in the module causes the processor to perform the process steps described herein. The embodiments of the present disclosure are not limited to any specific combination of hardware and software and the computer program code required to implement the foregoing can be developed by a person of ordinary skill in the art.

The term “computer-readable medium” as employed herein refers to any tangible machine-encoded medium that provides or participates in providing instructions to one or more processors. For example, a computer-readable medium may be one or more optical or magnetic memory disks, flash drives and cards, a read-only memory or a random access memory such as a DRAM, which typically constitutes the main memory. Such media excludes propagated signals, which are transitory and not tangible. Cached information is considered to be stored on a computer-readable medium. Common expedients of computer-readable media are well-known in the art and need not be described in detail here.

The Web has significantly increased the volume of data that are available to users, but meanwhile increased the difficulty for people to understand and digest the data. Too much information not only can cause information overload and a huge data aggregation cost, but sometimes can even harm the quality of the aggregation results. The presently described system aims at reducing the redundancy of data that must be handled, while obtaining similar or even higher quality of the integration results.

The foregoing detailed description is to be understood as being in every respect illustrative and exemplary, but not restrictive, and the scope of the disclosure herein is not to be determined from the description, but rather from the claims as interpreted according to the full breadth permitted by the patent laws. It is to be understood that various modifications of this disclosure will be implemented by those skilled in the art, without departing from the scope and spirit of the disclosure.

1. A method for selecting data sources for use in a data repository, the method comprising:
clustering, by a processor, potential data sources into domains based on a content of data included in the potential data sources;
determining, by the processor, relationships between the domains;
displaying, on a graphical user interface, a depiction of the potential data sources, the depiction including representations of the potential data sources clustered into the domains, the depiction further including representations of the relationships between the domains; and
receiving an identification of at least one user-identified data source of the potential data sources for use in the data repository.

2. The method of claim 1, further comprising:
receiving a keyword query identifying words relevant to the data repository;
by the processor, identifying the potential data sources, the identifying being based on the keywords.

3. The method of claim 1, wherein determining relationships between the domains includes identifying correlation between sources in different domains.

4. The method of claim 1, wherein determining relationships between the domains includes identifying co-occurrence of topics in sources in different domains.

5. The method of claim 1, wherein a single potential data source is clustered into more than one domain.

6. The method of claim 1, wherein the depiction further includes representations of the potential data sources clustered into subdomains of the domains.

7. The method of claim 1, wherein clustering the potential data sources into domains is further based on shared schema of the potential data sources.

8. The method of claim 1, wherein clustering the potential data sources into domains is further based on shared data instances of the potential data sources.

9. The method of claim 1, further comprising, for the user-identified data sources in a particular domain:
receiving, for each of the user-identified data sources in the particular domain, a measure of cost to use the data source;
determining a subset of the user-identified data sources in the particular domain yielding a maximum global economic effectiveness for the data repository, the global economic effectiveness being an overall quality of searches conducted using the data repository, discounted by the costs of the data sources in the data repository.

10-16. (canceled)

17. A tangible computer readable medium having computer readable instructions stored thereon for selecting data sources for use in a data repository, wherein execution of the computer readable instructions by a processor causes the processor to perform operations comprising:
clustering potential data sources into domains based on a content of data included in the potential data sources;
determining relationships between the domains;
displaying a depiction of the potential data sources, the depiction including representations of the potential data sources clustered into the domains, the depiction further including representations of the relationships between the domains; and
receiving an identification of at least one user-identified data source of the potential data sources for use in the data repository.

18. The tangible computer readable medium of claim 17, wherein the operations further comprise:
receiving a keyword query identifying words relevant to the data repository;
identifying the potential data sources, the identifying being based on the keywords.

19. The tangible computer readable medium of claim 17, wherein determining relationships between the domains includes identifying co-occurrence of topics in sources in different domains.

20. The tangible computer readable medium of claim 17, wherein the operations further comprise, for the user-identified data sources in a particular domain:
receiving, for each of the user-identified data sources in the particular domain, a measure of cost to use the data source;
determining a subset of the user-identified data sources in the particular domain yielding a maximum global economic effectiveness for the data repository, the global economic effectiveness being an overall quality of searches conducted using the data repository, discounted by the costs of the data sources in the data repository.

21. The tangible computer-readable medium of claim 17, wherein determining relationships between the domains includes identifying co-occurrence of topics in sources in different domains.

22. The tangible computer-readable medium of claim 17, wherein a single potential data source is clustered into more than one domain.

23. The tangible computer-readable medium of claim 17, wherein the depiction further includes representations of the potential data sources clustered into subdomains of the domains.

24. The tangible computer-readable medium of claim 17, wherein clustering the potential data sources into domains is further based on shared schema of the potential data sources.

25. The tangible computer-readable medium of claim 17, wherein clustering the potential data sources into domains is further based on shared data instances of the potential data sources.
